(19) United States
(12) Patent Application Publication
(10) Pub. No.: US 2023/0345881 A1
(43) Pub. Date: Nov. 2, 2023

(54) STAND FOR HAY BALES AND METHOD

(71) Applicant: Western Pro Feeders, LLC, Oklahoma City, OK (US)

(72) Inventors: Glen Leslie McAlister, Savery, WY (US); Robert Brent Hammons, Edmond, OK (US)

(73) Assignee: Western Pro Feeders, LLC, Oklahoma City, OK (US)

(21) Appl. No.: 18/219,487

(22) Filed: Jul. 7, 2023

Related U.S. Application Data
(63) Continuation-in-part of application No. 17/362,920, filed on Jun. 29, 2021.
(60) Provisional application No. 63/045,545, filed on Jun. 29, 2020.

(51) Int. Cl. A01F 25/04

(52) U.S. Cl. CPC A01F 25/04

(57) ABSTRACT

This invention relates to a stand for supporting hay bales above the ground. The inventive hay stand The device is formed in the shape of an rectangular prism or cuboid from an inert plastic, closed-cell, polyurethane structural foam that will not allow water or air to move through it. The devices are constructed by pouring the structural foam material into forms that are constructed to yield the desired shape. The structural foam has two chemicals that are mixed and then poured into the form. The foam then heats and rises to take on the shape of the interior of the form. Once the foam is fully cured, the forms are removed, and the device is ready for use. Hay stands constructed in accordance with the present invention are useful for protecting hay bales from spoilage due to ground moisture.

### CROSS REFERENCE TO RELATED APPLICATIONS

This application claims the benefit of U.S. provisional application No. 63/045,545 entitled “Hay Saver,” filed Jun. 29, 2020, the contents of which are incorporated herein by reference. This application further claims the benefit of U.S. application Ser. No. 17/362,920 entitled “Stand for Hay Bales and Method,” filed Jun. 29, 2021, the contents of which are incorporated herein by reference.

### FIELD OF THE INVENTION

The present invention relates to the field of stands for supporting hay bales above the ground.

### BRIEF DESCRIPTION OF THE DRAWINGS

The accompanying drawings, which are incorporated into and form a part of the specification, illustrate one or more embodiments of the present invention and, together with this description, serve to explain the principles of the invention. The drawings merely illustrate preferred embodiments of the invention and are not to be construed as limiting the scope of the invention.

FIG. 1 is a perspective view of a preferred embodiment of the present invention.

FIG. 2 is a side view of a form used to make a preferred embodiment of the present invention.

FIG. 3 is a perspective view of the embodiment of FIG. 1 supporting a bale of hay.

FIG. 4 is a side view of the embodiment of FIG. 1 supporting a bale of hay.

FIGS. 5A and 5B are plan and side views of an alternative embodiment of the present invention.

FIG. 6 is a perspective view of the embodiment of FIGS. 5A and 5B.

FIG. 7 is a perspective view of the embodiment of FIGS. 5A and 5B supporting a hay bale.

FIG. 8 is a side view of the embodiment of FIGS. 5A and 5B supporting a hay bale.

FIG. 9 is a perspective view of the embodiment of FIGS. 5A and 5B.

FIG. 10 is a perspective view the embodiment of FIGS. 5A and 5B.

FIG. 11 is a plan view of another alternative embodiment of the present invention.

FIG. 12 is a side view of the alternative embodiment of FIG. 11.

FIG. 13 is an end view of the alternative embodiment of FIG. 11.

FIG. 14 is a perspective view of the alternative embodiment of FIG. 11 before the coating is applied.

FIG. 15 is a perspective view of the alternative embodiment of FIG. 11 after the coating is applied.

FIG. 16 is a perspective view of the alternative embodiment of FIG. 11 showing it supporting a round hay bale.

FIG. 17 is a side view of the alternative embodiment of FIG. 11 showing it supporting two rectangular hay bales.

### DETAILED DESCRIPTION OF THE PREFERRED EMBODIMENT(S)

The present invention provides a stand for hay bales. Hay bales stored on the ground outdoors can take on moisture, leading to early deterioration and as much as 50% spoilage of the hay. Devices constructed in accordance with the present invention are useful for protecting hay bales from spoilage due to ground moisture. The device is economically advantageous and is useful for both round and square bales of hay and other animal feedstock provided in bales (collectively “hay”).

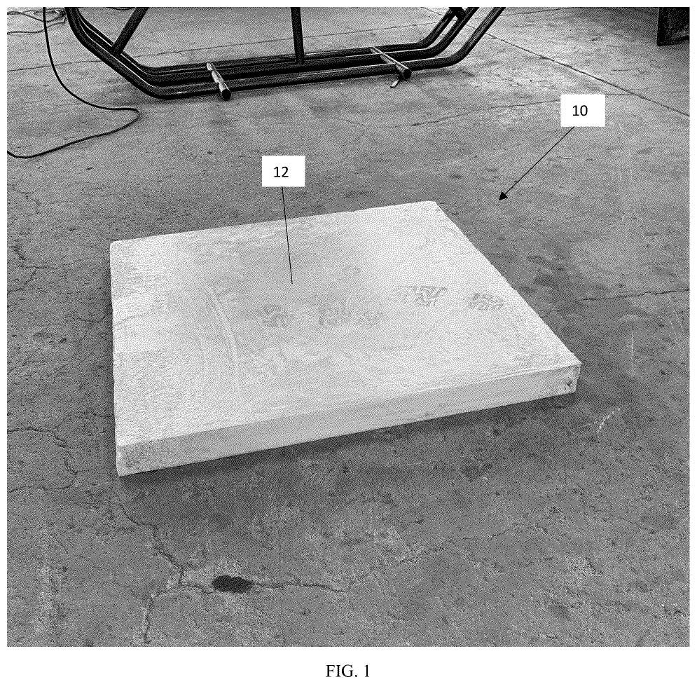

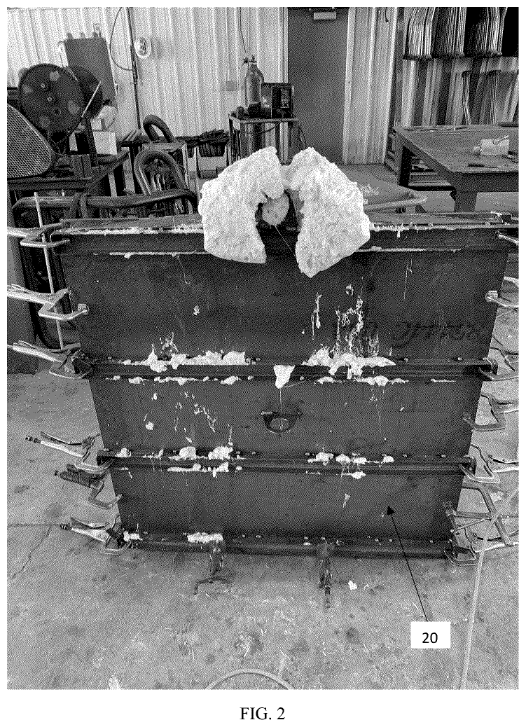

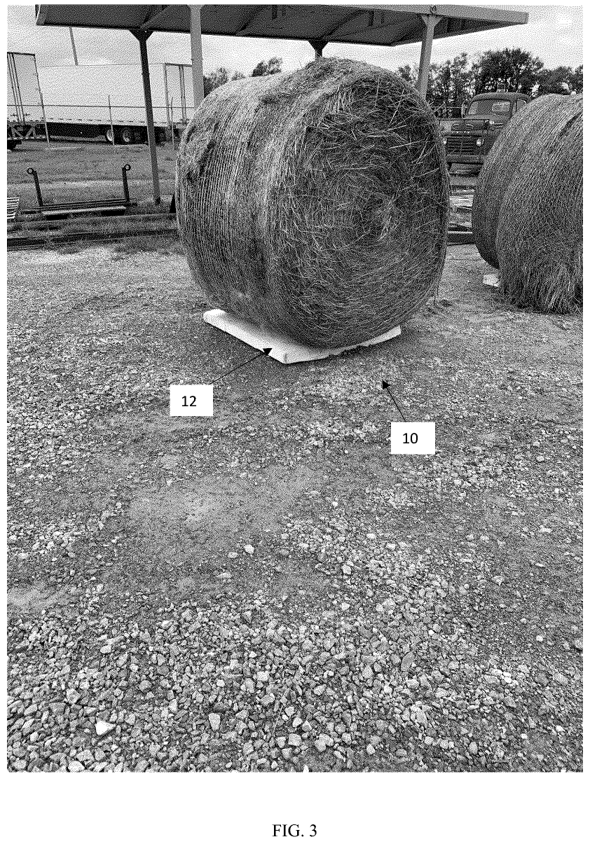

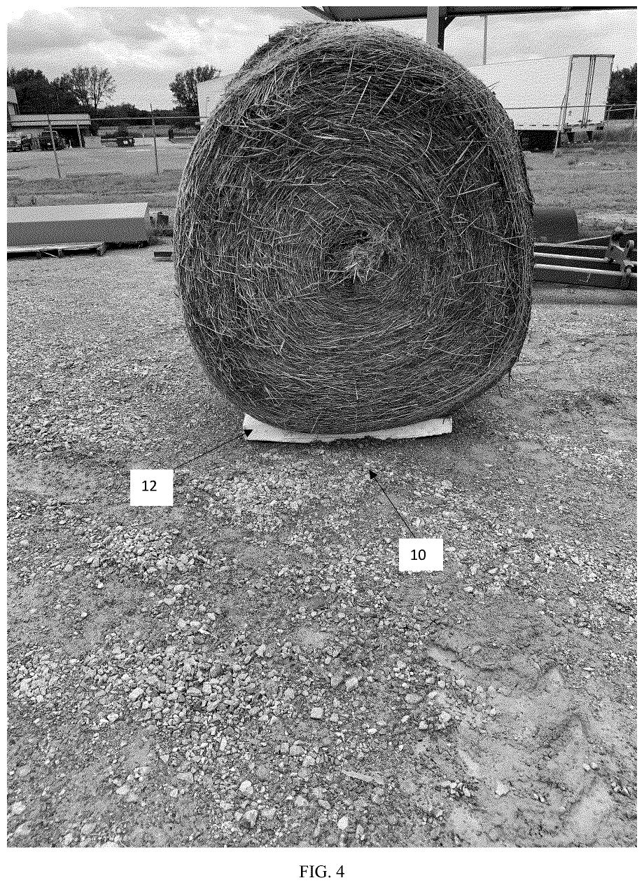

FIGS. 1-4 show one embodiment of a hay stand 10 constructed in accordance with the present invention. The hay stand 10 has a solid body 12 that is preferably formed in the shape of a rectangular prism or cuboid. Persons skilled in the art will recognize other shapes suitable for the present invention. The solid body 12 of the hay stand 10 is formed from an inert plastic, closed-cell, polyurethane structural foam that will not allow water or air to move through it. A particularly well-suited structural foam product is sold by GRA Services International of Oklahoma City, Oklahoma under the Secure Set trademark. Such material does not leach and has no nutritional value that would promote fungicidal or bacterial growth. It also has no effect on the soil or hay. The hay stand 10 is lightweight and can be stacked for storage or transportation. In some embodiments, the hay stand 10 is constructed with a reinforced hole (not shown) that can be used with a stacking rack having a base and a vertical dowel or rod (not shown). The hay stands 10 are stacked onto the stacking rack by threading the reinforced hole onto the vertical rod. This allows for convenient and organized storage of multiple hay stands.

The body 12 of the hay stand 10 is constructed by pouring the structural foam material into a form 20 that is constructed to yield the desired shape. The structural foam has two chemicals that are mixed and then poured into the form 20. The foam then heats and rises to take on the shape of the interior of the form 20. Once the foam is fully cured, the form is removed, and the hay stand is ready for use. In some embodiments, a small piece of PVC (not shown) is inserted into the form 20, causing the structural foam to mold around the PVC. This provides a reinforced hole which can be used to stack multiple hay stands on a stacking rack.

To use the device, a user simply transports the hay stand 10 to the location where hay is to be located and places the hay stand 10 on the ground. Round or square bales can then be placed on top of the hay stand 10. When the hay is removed from the hay stand 10, it can be easily picked up by the user and stored, transported or repositioned.

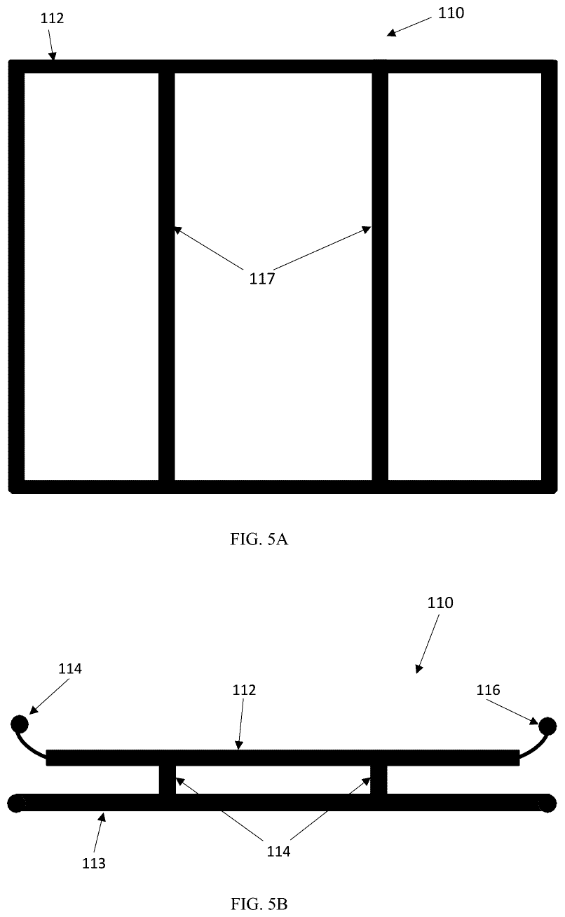

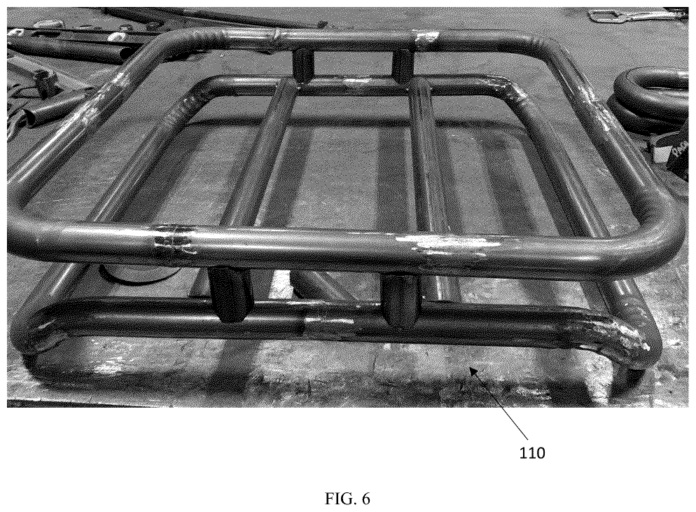

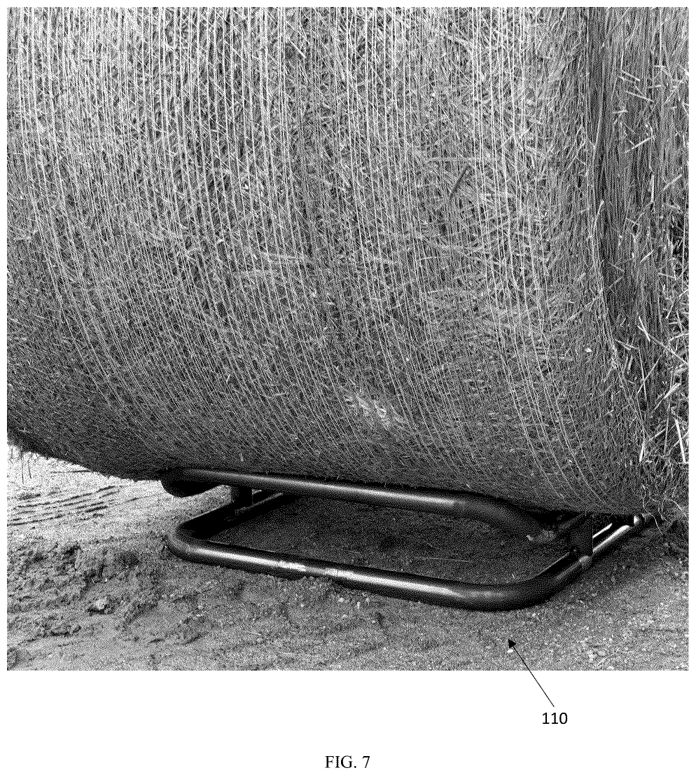

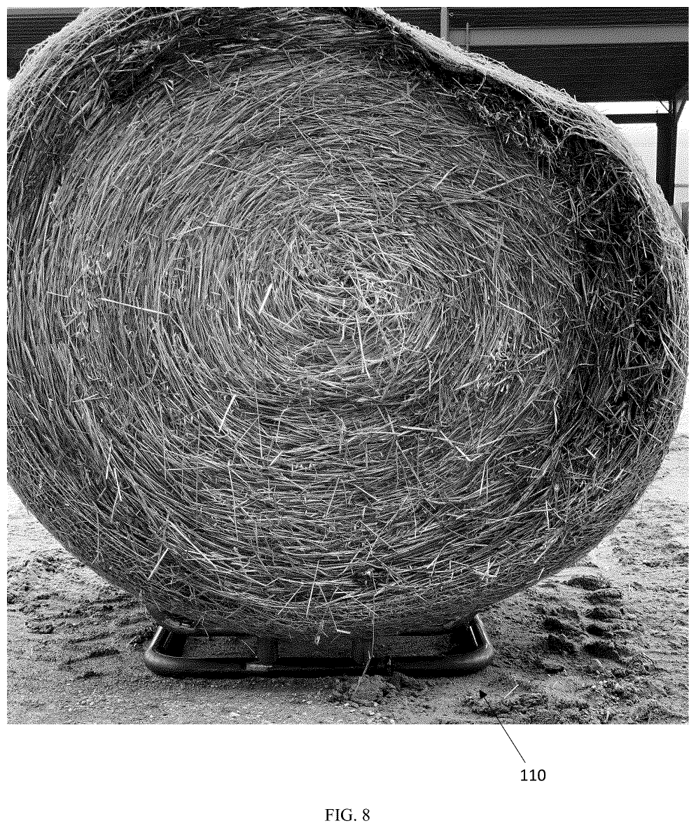

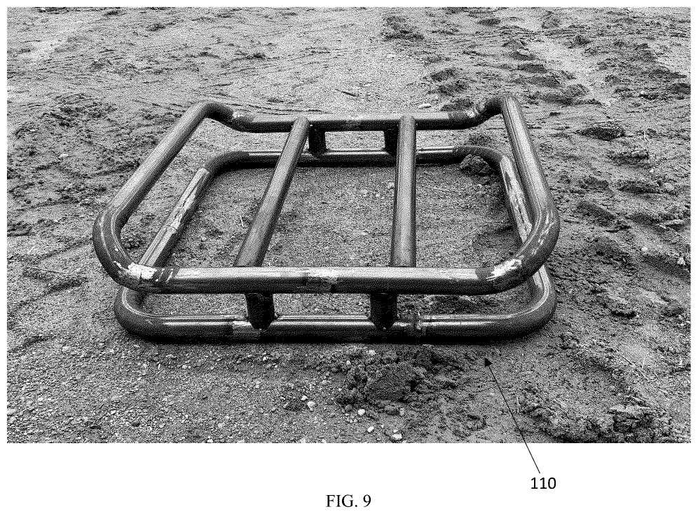

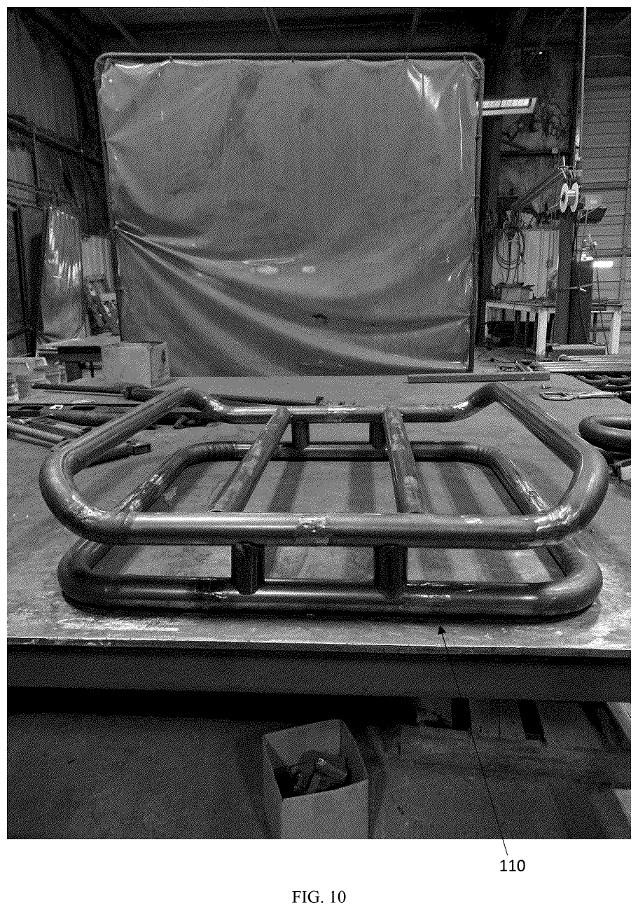

An alternative embodiment of the hay stand 110 is shown in FIGS. 5-10. The hay stand 110 includes an upper body 112 and a lower body 113 connected by a plurality of vertical supports 115. The lower body 113 lies on the ground and is generally planar. The upper body 112 includes two upwardly extending abutments 114, 116 that extend along opposing sides of the upper body 112, as shown. In some embodiments, the upper body 112 includes a plurality of lateral supports 117. These devices can be made from welded metal, such as round or square tubing, or any other suitably strong material. The details of construction will be apparent to those skilled in the art from the drawings. In use, the device can be used for round bales when the curved side is facing upwards or can be used for square bales when the curved side is facing downward.

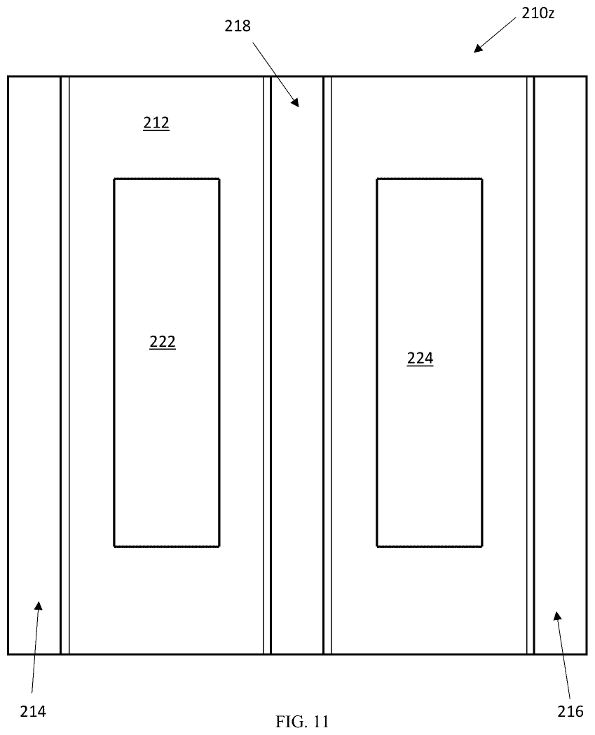

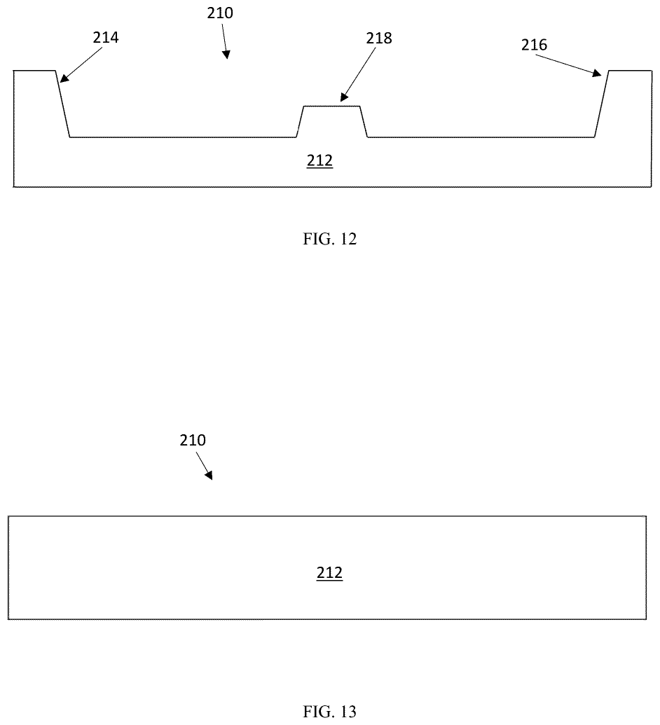

Yet another embodiment of the hay stand 210 is shown in FIGS. 11-17. In this embodiment, the hay stand 210 comprises a body 212 that has two upwardly extending abutments 214, 216 that extend along opposing sides of the body 212, as shown. The body 212 also includes an upwardly extending center support 218 that extends generally parallel to abutments 214, 216. In some embodiments the center support 218 will be somewhat shorter in height than the abutments 214, 216. In this manner, the hay stand 210 forms an upside down “M” shape that creates a cradle for the hay bale(s). The center support 218 helps to keep the bottom center of the hay bale above the ground to help keep moisture off the bale and provide ventilation to prevent mold and mildew from forming underneath the bale. In some embodiments, the body 212 further includes two openings 222, 224 that extend through the body 212. One of the openings is located between abutment 212 and center support 218 and the other opening is located between abutment 214 and center support 218. The openings 222, 224 provide a means for air circulation and water drainage and also reduce the amount of material used to construct hay stand 210. Although the openings 222, 224 are shown as generally rectangular in shape, persons skilled in the art will recognize that other shapes for the openings 222, 224 would be equally suitable in accordance with the present invention.

The present invention is preferably constructed from structural foam. Such structural foams generally fall into two categories: thermosets and thermoplastics. Thermoplastics, such as nylon, Acrylonitrile Butadiene Styrene (ABS), and Polypropylene (PP), are commonly formed by frothing a liquified material with inert gas during a classic injection molding process. Thermosets, on the other hand, such as polyurethanes, are produced by the chemical reaction of polyols and diisocyanates. Thermoset polyurethanes can often be transformed from a solid to foam by introducing blowing agents during a Reaction Injection Molding (RIM) process. In some embodiments, additives may be used to tailor the physical properties of the urethane to meet specific design and performance requirements.

In some embodiments, the hay stand 210 is constructed from expanded polystyrene foam, a thermoplastic. Expanded polystyrene foam (EPS) is a lightweight and versatile material commonly used in packaging, insulation, and construction applications. It is made by expanding polystyrene beads with the help of steam, which results in a rigid foam material with a closed-cell structure. EPS can be easily molded into customized shapes using a process called molding or shaping. Persons skilled in the art will recognize that other types of structural foam can be used consistent with the present invention. This process generally involves a number of steps.

Designing the Mold: The first step is to create a mold that matches the desired shape of the hay stand 210. The mold can be made of various materials, such as aluminum or steel, depending on the complexity and durability requirements of the shape.

Preparing the EPS Beads: In one embodiment, the expanded polystyrene beads are supplied as small, spherical beads. These beads are preferably pre-expanded and have a low density, making them easy to mold. These beads can be purchased from EPS manufacturers or can be produced on-site using specialized equipment.

Charging the Mold: The mold is opened, and the pre-expanded EPS beads are poured or injected into the mold cavity. The amount of beads used depends on the desired density and thickness of the final product. The mold is then closed tightly, ensuring that the beads are contained within the mold cavity.

Applying Heat: To shape the EPS beads and fuse them together, heat is applied to the mold. Steam or hot air can be used to heat the mold and the EPS beads inside. The heat causes the beads to soften and expand further, while the steam or hot air ensures even distribution of heat throughout the mold.

Fusion and Expansion: As the EPS beads heat up, a blowing agent that is incorporated into the beads expands, creating pressure within the mold. The softening beads begin to fuse together, forming a solid mass that takes the shape of the mold cavity. The heat also causes the blowing agent to release gas, creating the characteristic closed-cell structure of EPS foam.

Cooling and Solidification: Once the desired shape is formed, the heat source is removed, and the mold is allowed to cool. Cooling can be facilitated by circulating cold air or water through the mold. As the foam cools, it solidifies and retains the shape of the mold.

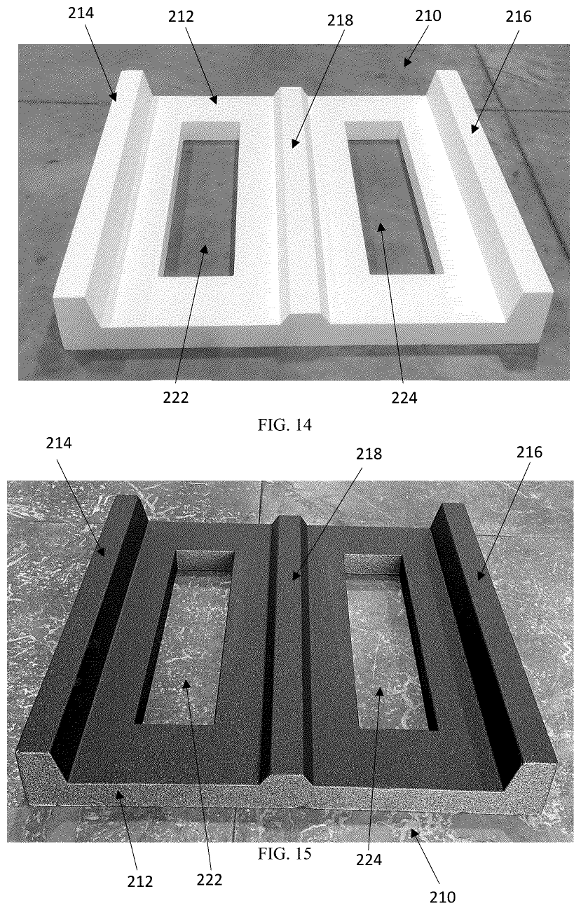

Demolding: After the EPS foam has cooled and solidified, the mold is opened, and the newly formed foam product is removed. Any excess foam material or flash that may have formed during the molding process is trimmed or removed to achieve the final shape, as shown in FIG. 14.

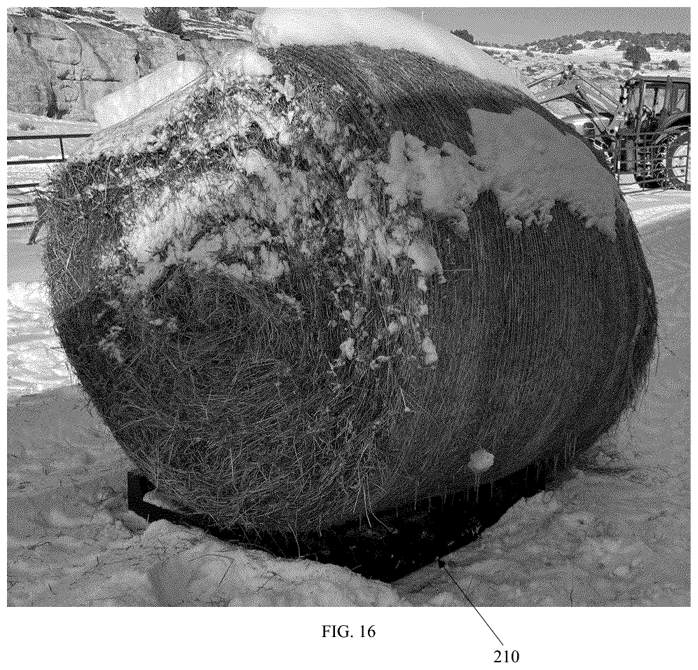

Finishing: In some embodiments, the molded EPS foam product may undergo further processing or finishing steps. This can include hot wire cutting via CNC hot wire cutting (or manually via hot wire), sanding, coating, painting, or laminating to enhance its appearance or performance. In the present embodiment, the molded or cut EPS foam is coated with a protective coating, such as polyurethane or Polyurea coating, as shown in FIG. 15. The coating material is applied by spraying the coating material onto the hay stand 210.

While molding is the presently preferred process for making the present invention, in some embodiments the hay stand 210 may be partially or entirely formed and shaped via hot wire cutting such as by a CNC hot wire cutting machine. In such embodiments, precision molding of the product will not be necessary, and the hay stand 210 can be formed from a rough block of the structural foam via hot wire cutting techniques.

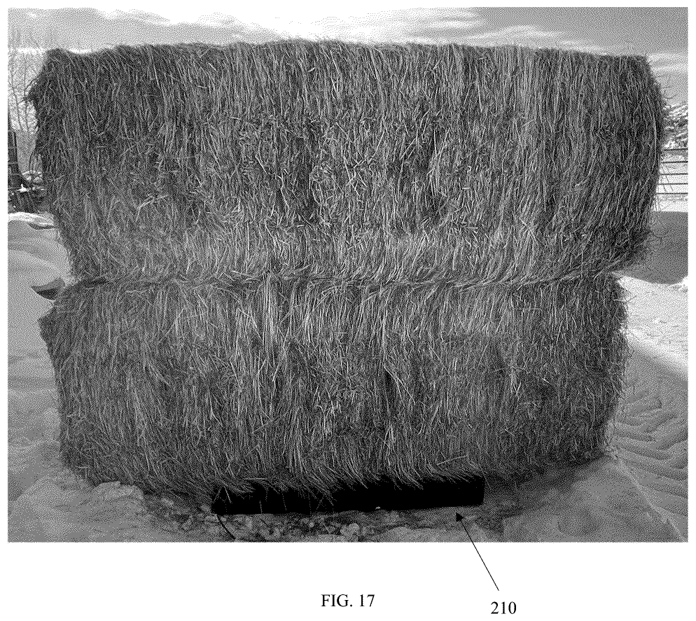

The hay stand 210 of the present invention provides a light weight, yet durable product that can be placed on the ground at the location where hay is to be stored. As shown in FIGS. 16 and 17, the hay stand 210 can support either round or square/rectangular bales and keep the bales off the ground, helping to prevent spoilage of the livestock feed material.

A round bale can be placed on the hay stand 210 using conventional farm equipment, with the central axis of the bale being generally parallel to the longitudinal direction of abutments 216, 218. The upwardly extending abutments 216, 218 help prevent the round bale from rolling off of hay stand 210.

Although the preferred embodiment has been described in detail, it should be understood by those skilled in the art that various changes, substitutions, and alterations can be made therein without departing from the spirit and scope of the invention as defined by the appended claims.

1. A hay stand for supporting hay above the ground comprising:
a body having opposing sides; and
wherein the body is formed of polyurethane structural foam.

2. The hay stand of claim 1 wherein the body is formed in the shape of a rectangular prism or cuboid.

3. The hay stand of claim 1 further comprising two upwardly extending abutments that extend along opposing sides of the body.

4. The hay stand of claim 3 further comprising an upwardly extending center support that is generally parallel to the upwardly extending abutments.

5. The hay stand of claim 4 further comprising a plurality of openings in the body.

6. A hay stand for supporting a bale of hay above the ground comprising:
a body having opposing sides, two upwardly extending abutments that extend along the opposing sides of the body, and an upwardly extending center support that is generally parallel to the upwardly extending abutments; and
wherein the body is formed of structural foam.

7. The hay stand of claim 6 wherein the body has a plurality of openings.

8. The hay stand of claim 6 wherein the structural foam is expanded polystyrene foam.

9. The hay stand of claim 6 wherein the structural foam is polyurethane structural foam.

10. The hay stand of claim 6 wherein the structural foam body is formed by molding.

11. A hay stand for supporting a bale of hay above the ground comprising:
a body having opposing sides, two upwardly extending abutments that extend along the opposing sides of the body, an upwardly extending center support that is generally parallel to the upwardly extending abutments, and a plurality of openings; and
wherein the body is formed of expanded polystyrene foam.

12. The hay stand of claim 11 wherein the foam body is formed by molding.
